(19) United States
(12) Patent Application Publication
(10) Pub. No.: US 2011/0222943 A1
(43) Pub. Date: Sep. 15, 2011

(54) IMAGE FORMATION APPARATUS AND READABLE MEDIUM

(75) Inventor: Tamaki TANAKA, Kanagawa (JP)

(73) Assignee: FUJI XEROX CO., LTD., Tokyo (JP)

(21) Appl. No.: 12/869,814

(22) Filed: Aug. 27, 2010

(30) Foreign Application Priority Data
Mar. 15, 2010 (JP) 2010-057492

(51) Int. Cl. G03G 15/00

(52) U.S. Cl. 399/391

(57) ABSTRACT

An image formation apparatus includes: an acquisition unit that reads an original and acquires image data; a plurality of accommodation units that accommodate therein printing media on which images are to be formed; and an accommodated-printing-medium setting unit that sets an accommodated-printing-medium size which is a size of the printing medium accommodated in each of the accommodation unit, and an accommodated-printing-medium sort which is a sort of the printing medium. The image formation apparatus further includes a selected-printing-medium setting unit that sets a selected-printing-medium sort; a determination unit that determines a determined-printing-medium size; a selection unit that selects the accommodation unit in which the printing medium of the accommodated-printing-medium sort of single sort and the accommodated-printing-medium size corresponding to the determined-printing-medium size is accommodated; and an image formation unit that forms the image on the printing medium which is accommodated in the accommodation unit selected by the selection unit.

### CROSS-REFERENCE TO RELATED APPLICATION

This application is based on and claims priority under 35 USC 119 from Japanese Patent Application No. 2010-057492 filed on Mar. 15, 2010.

### BACKGROUND

### Technical Field

The present invention relates to an image formation apparatus and a readable medium.

### SUMMARY

According to an aspect of the invention, an image formation apparatus includes:

an acquisition unit that reads an original and acquires image data;

a plurality of accommodation units that accommodate therein printing media on which images are to be formed;

an accommodated-printing-medium setting unit that sets an accommodated-printing-medium size which is a size of the printing medium accommodated in each of the accommodation unit, and an accommodated-printing-medium sort which is a sort of the printing medium;

a selected-printing-medium setting unit that sets a selected-printing-medium sort which is the sort of the printing medium for selecting any of the respective accommodation unit;

a determination unit that determines a determined-printing-medium size which is the size of the printing medium for forming thereon the image of the original read by the acquisition unit;

a selection unit that selects the accommodation unit in which the printing medium of the accommodated-printing-medium sort of single sort and the accommodated-printing-medium size corresponding to the determined-printing-medium size is accommodated, even when the selected-printing-medium sort does not correspond to the single sort in a selection function, in a case where the accommodated-printing-medium sort as to the accommodation unit which is selected by the selection function of selecting the accommodation unit that accommodates therein the printing medium of the accommodated-printing-medium size corresponding to the determined-printing-medium size and the accommodated-printing-medium sort corresponding to the selected-printing-medium sort is the single sort; and

an image formation unit that forms the image on the printing medium which is accommodated in the accommodation unit selected by the selection unit, on the basis of the image data acquired by the acquisition unit.

### BRIEF DESCRIPTION OF THE DRAWINGS

Exemplary embodiments of the invention will be described in detail based on the following figures, wherein:

FIG. 1 is a view showing the configuration of an image formation apparatus in an exemplary embodiment;

FIG. 2 is a block diagram showing constituents which are electrically connected in the image formation apparatus;

FIG. 3 is a view showing the configuration of an original read device;

FIG. 4 is a plan view showing the schematic configuration of an original supply portion;

FIG. 5 is a plan view showing the arrangement of original detection sensors which a scanner unit includes;

FIG. 6 is a block diagram showing a system control portion functionally;

FIG. 7 is a flow chart showing the processing steps of an attribute setting processing portion;

FIG. 8 is a diagram showing a display example of a screen for setting an attribute (a main screen);

FIG. 9 is a diagram showing a display example of a setting screen in the case where “tray priority level setting” has been selected;

FIG. 10 is a diagram showing a display example of a setting screen in the case where “paper sheet size setting” has been selected;

FIG. 11 is a diagram showing a display example of a setting screen in the case where “paper quality setting” has been selected;

FIG. 12 is a diagram showing a display example of a setting screen in the case where “paper sheet color setting” has been selected;

FIG. 13 is a flow chart showing the processing steps of an automatic paper sheet selection setting process portion;

FIG. 14 is a flow chart showing the processing steps of an automatic paper sheet selection process portion;

FIG. 15 is a flow chart showing the processing steps (subroutine) of the automatic paper sheet selection process of the automatic paper sheet selection process portion;

FIG. 16 is a flow chart showing the processing steps (subroutine) of the paper sheet accommodation portion selection process of the automatic paper sheet selection process portion;

FIG. 17 is a flow chart showing the processing steps of a transport control portion; and

FIG. 18 is a diagram used for explaining operations based on practicable examples.

### DETAILED DESCRIPTION

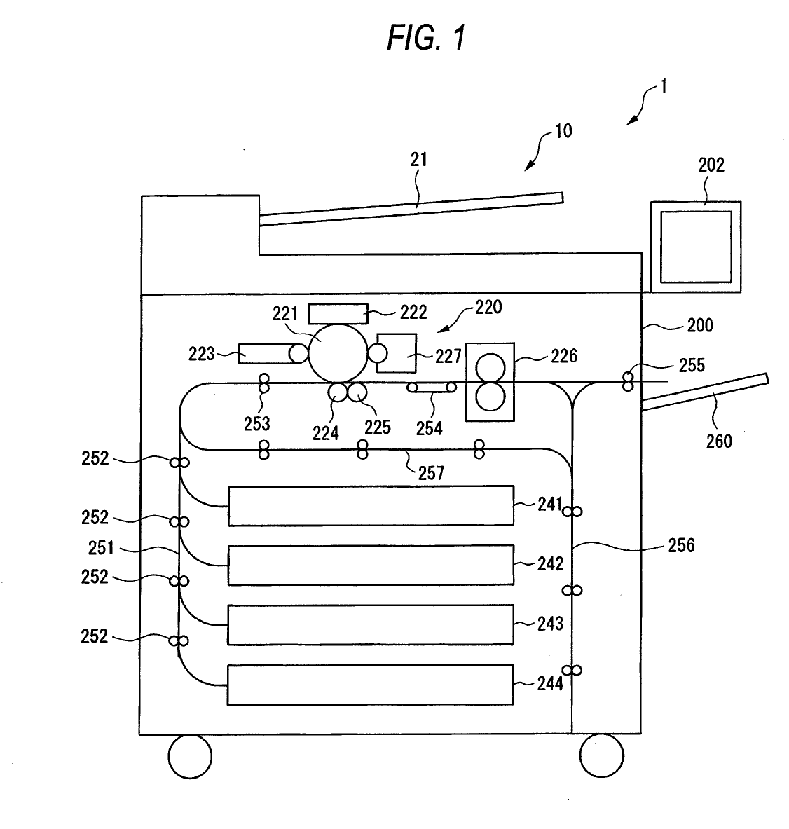

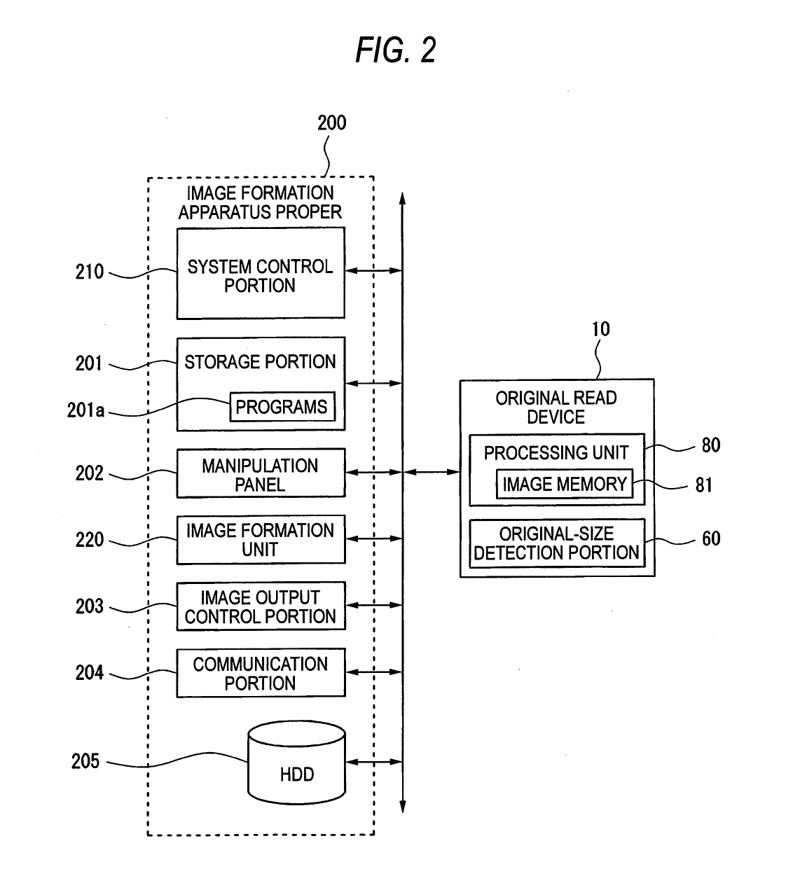

FIG. 1 is a schematic diagram of an image formation apparatus in an exemplary embodiment. FIG. 2 is a block diagram showing constituents which are electrically connected in the image formation apparatus 1.

As shown in FIGS. 1 and 2, the image formation apparatus 1 has an original read device 10 and the image formation apparatus proper 200. Besides, as shown in FIG. 2, the image formation apparatus 1 includes a system control portion 210, a storage portion 201, a manipulation panel 202, an image formation unit 220, an image output control portion 203, a communication portion 204 and an HDD (Hard Disk Drive) 205. As shown in FIG. 2, the system control portion 210, etc. are electrically interconnected, and the system control portion 210, etc. and the original read device 10 are electrically connected, whereby data may be transmitted and received. Besides, as shown in FIG. 2, the system control portion 210, the storage portion 201, the manipulation panel 202, the image formation unit 220, the image output control portion 203, the communication portion 204 and the HDD 205 are configured in the image formation apparatus proper 200. For example, the system control portion 210 and the storage portion 201 are configured as an arithmetic processing portion in the image formation apparatus 1.

The system control portion 210 is configured so as to execute the processing of the whole image formation apparatus 1. The storage portion 201 stores therein programs 201a, data, etc. which the system control portion 210, the image output control portion 203, etc. use for processes. The process by the system control portion 210 will be described in detail later.

Here, the programs 201a may be stored in the storage portion 201 from the beginning at the shipment of the image formation apparatus 1, but they may also be stored in the storage portion 201 in such a way that they are loaded from a CD-ROM or the like storage medium by the operation of a user or the like after the shipment.

The manipulation panel 202 includes a display device (display portion) which displays contents to be notified to the user, and an input portion to which the instruction contents of the user are inputted. Input information items from the manipulation panel 202 are outputted to the system control portion 210, the image output control portion 203, etc.

The communication portion 204 serves for the image formation apparatus 1 to communicate with external equipments. By way of example, the communication portion 204 serves to perform facsimile communications by utilizing a general public network.

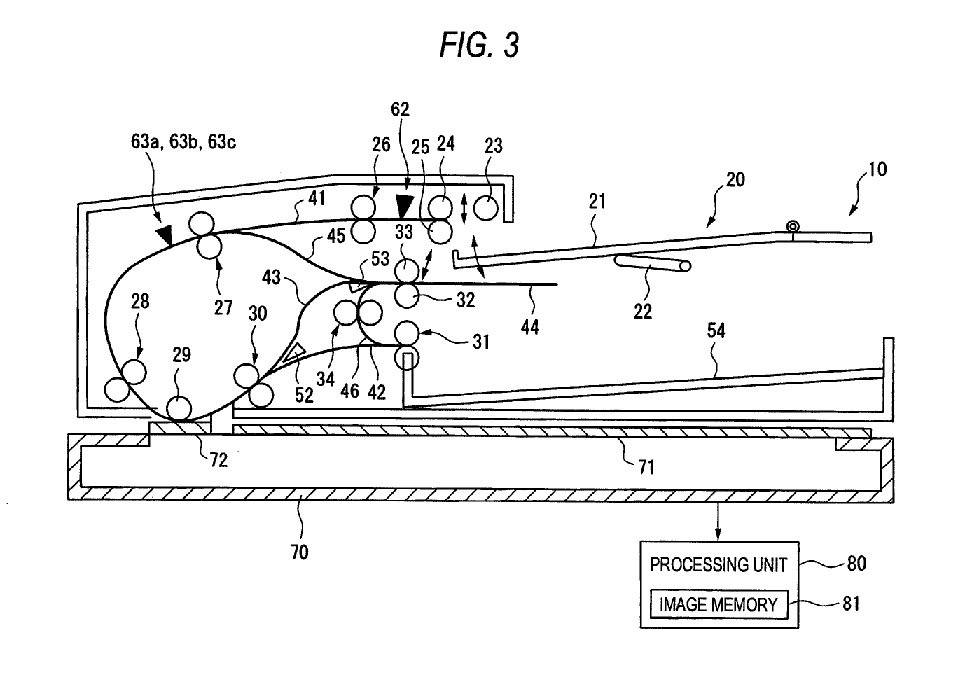

The original read device 10 reads an original and outputs image data. FIG. 3 is a view showing the schematic configuration of the original read device 10. As shown in FIG. 3, the original read device 10 includes an original feed unit 20, a scanner unit 70 and a processing unit 80.

The original feed unit 20 includes an original supply portion 21, a lift support portion 22, a transport roll (pickup roll) 23, a supply roll 24 and a retard roll 25. The original supply portion 21, etc. constitute a transport portion which successively transports originals put on the original supply portion 21, in the original feed unit 20.

The original supply portion 21 defines a shape in which the original may be located. This original supply portion 21 is capable of placing the originals of different sizes thereon. It is manipulated to ascend and descend by the lift support portion 22.

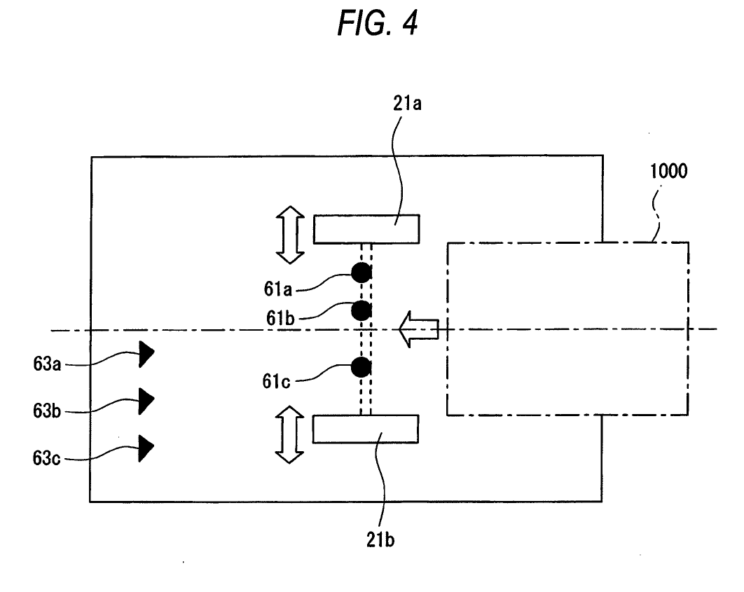

FIG. 4 is a plan view showing the schematic configuration of the original supply portion 21.

As shown in FIG. 4, first and second guide members 21a and 21b which guide both the end parts of the original 1000 (both the sides of the original in the widthwise direction thereof) are disposed on the upper surface of the original supply portion 21.

The first and second guide members 21a and 21b may come near to or away from each other by a slot or the like which is provided in the original supply portion 21. Guide member movement sensors 61a, 61b and 61c are disposed on the original supply portion 21. The guide member movement sensors 61a, 61b and 61c detect the movements of the first and second guide members 21a and 21b in interlocking with these movements of the first and second guide members 21a and 21b. The guide member movement sensors 61a, 61b and 61c output detection signals to the system control portion 210. Incidentally, the guide member movement sensors 61a, 61b and 61c constitute an original-size detection portion 60 shown in FIG. 2.

Back to the description of the configuration shown in FIG. 3, the transport roll 23 delivers the original on the original supply portion 21 caused to ascend by the lift support portion 22, to a first transport path 41 in the original feed unit 20. Concretely, the transport roll 23 ascends during standby and is held at a retraction position, whereas it descends to a nip position (original transport position) when to deliver the original and delivers the original (the uppermost original in an original bundle) on the original supply portion 21, to the first transport path 41.

The supply roll 24 transports the original delivered by the transport roll 23, onto a downstream side more. The transport roll 23 and the supply roll 24 transports the original by the coupling of a feed clutch (not shown). The retard roll 25 separates the originals supplied by the transport roll 23, one by one.

Besides, the original feed unit 20 includes a plurality of rolls in the first transport path 41 by which the original is first transported. Concretely, the original feed unit 20 includes take-away rolls 26, pre-registration rolls 27, registration rolls 28, a platen roll 29 and out rolls 30, in the first transport path 41.

The take-away rolls 26 exist on the downstream side of the retard roll 25, and they transport the originals separated one by one by this retard roll 25, to the pre-registration rolls 27 on the downstream side. The pre-registration rolls 27 transport the original transported by the take-away rolls 26, to the registration rolls 28 on the downstream side.

The registration rolls 28 are rotating in accordance with the start timing of the read of the original, and they supply the original to the platen roll 29 (scanner unit 70) while making a registration adjustment.

The platen roll 29 assists the transport of the original which is being read. Concretely, the platen roll 29 presses the original supplied by the registration rolls 28, onto the side of the second platen glass 72 of the scanner unit 70 as will be stated later. The out rolls 30 transport the read original downstream more.

Besides, the original feed unit 20 includes transported-original detection sensors 62, 63a, 63b and 63c in the first transport path 41. The transported-original detection sensor 62 is arranged at a stage succeeding to the supply roll 24. On the other hand, the transported-original detection sensors 63a, 63b and 63c are arranged between the pre-registration rolls 27 and the registration rolls 28. These transported-original detection sensors 63a, 63b and 63c are arranged so as to be arrayed in the widthwise direction (main scanning direction) of the original which is transported. The transported-original detection sensors 62, 63a, 63b and 63c output detection signals to the system control portion 210.

Incidentally, the transported-original detection sensors 62, 63a, 63b and 63c constitute the original-size detection portion 60 shown in FIG. 2.

Besides, the original feed unit 20 is furnished with a second transport path 42 and a third transport path 43 on the downstream side of the out rolls 30. Further, the original feed unit 20 includes a switch gate 52 and first ejection rolls 31 on the downstream side of the out rolls 30.

The switch gate 52 performs the switching between the second transport path 42 and the third transport path 43, thereby to switch the transport direction of the original. Concretely, the switch gate 52 is switched so as to lead the original supplied from the out rolls 30, to the second transport path 42 when the read of a single-sided original has ended or when the double-sided read of a double-sided original has ended. On the other hand, the switch gate 52 is switched so as to lead the double-sided original to the third transport path 43 for the purpose of inverting the double-sided original after the single-sided read thereof.

The first ejection rolls 31 eject the original supplied from the out rolls 30, to an ejection portion 54 at the end of the read of the single-sided original, or the like. The ejection portion 54 defines a shape in which the originals may be stacked.

Besides, the original feed unit 20 is furnished with a fourth transport path 44 and a fifth transport path 45. These fourth and fifth transport paths 44 and 45 and the above-stated third transport path 43 constitute transport paths which invert the originals, in the original feed unit 20. Therefore, the third transport path 43 and the fourth transport path 44 are joined, while the fourth transport path 44 and the fifth transport path 45 are joined. Further, the fifth transport path 45 and the first transport path 41 are joined.

The original feed unit 20 includes an inverter roll 32 and an inverter pinch roll 33 in the fourth transport path 44. The inverter roll 32 and the inverter pinch roll 33 switch back the original transported along the third transport path 43. Concretely, in reading the double-sided original, the inverter pinch roll 33 is retracted and is released from its nip in the OFF state of a feed clutch not shown, thereby to lead the original transported along the third transport path 43, to the fourth transport path 44. Thereafter, the inverter pinch roll 33 is nipped, whereby the inverter roll 32 leads the original to the pre-registration rolls 27 existing in the first transport path 41, through the fifth transport path 45.

Besides, the original feed unit 20 is furnished with a sixth transport path 46. The sixth transport path 46 serves as a transport path for ejecting the original transported from the third transport path 43 to the fourth transport path 44, into the ejection portion 54. The original feed unit 20 includes a switch gate 53 and second ejection rolls 34 in the sixth transport path 46.

The switch gate 53 performs the switching between the fifth transport path 45 and the sixth transport path 46, thereby to switch the transport direction of the original. Concretely, the switch gate 53 is switched so as to lead the original transported by the inverter pinch rolls 33, to the sixth transport path 46 when to invert and eject the original. The second ejection rolls 34 transport the original transported to the sixth transport path 46, to the first ejection rolls 31. The first ejection rolls 31 eject the original supplied from the inverter pinch roll 33, into the ejection portion 54.

Owing to the configuration of the original read device 10 as stated above, when the single-sided original is to be read, the original put on the original supply portion 21 is delivered into the original feed unit 20 by the transport roll 23. Thereafter, the original is transported by the supply roll 24, the take-away rolls 26, the pre-registration rolls 27 and the registration rolls 28 along the first transport path 41. In addition, when the original passes on the second platen glass 72 of the scanner unit 70 as will be stated later, it is pressed onto the side of this second platen glass 72 by the platen roll 29 and is transported to the out rolls 30. Thereafter, the original is led to the second transport path 42 by the out rolls 30 and is ejected into the ejection portion 54 by the first ejection rolls 31.

Besides, when the double-sided original is to be read, one side thereof is read in the same manner as in the read of the single-sided original. Thereafter, the double-sided original is transported along the third transport path 43 by the out rolls 30 so as to be led to the fourth transport path 44. In addition, the double-sided original is switched back by the inverter roll 32 and the inverter pinch roll 33 which exist in the fourth transport path 44, and it is led to the pre-registration rolls 27 which exist in the first transport path 41. Thereafter, the double-sided original is transported along the first transport path 41 again by the pre-registration rolls 27 and the registration rolls 28. Besides, in passing on the second platen glass 72 of the scanner unit 70 as will be stated later, the double-sided original is pressed onto the side of the second platen glass 72 by the platen roll 29, thereby to be transported to the out rolls 30. Thereafter, the double-sided original is led to the second transport path 42 by the out rolls 30, and it is ejected into the ejection portion 54 by the first ejection rolls 31.

The scanner unit 70 is configured so as to perform the image read of the original transported by the original feed unit 20.

As shown in FIG. 3, the scanner unit 70 includes a first platen glass 71 for reading the image of the original which is placed every sheet, and the second platen glass 72 for reading the original which is transported by the original feed unit 20. The second platen glass 72 is a glass plate of elongate flat structure extending in the main scanning direction.

In reading the image of the original put on the first platen glass 71, the scanner unit 70 performs the read in such a way that, while light projected toward the original from the rear surface of the first platen glass 71 is being moved in a sub scanning direction, the reflection light thereof is received by a CCD (Charge Coupled Device) image sensor which is unidimensionally arrayed in the main scanning direction.

Besides, in reading the image of the original which is transported by the original feed unit 20, the scanner unit 70 performs the read in such a way that the reflection light of light projected from the rear surface of the second platen glass 72 toward the original which passes on the second platen glass 72 is received by the CCD image sensor.

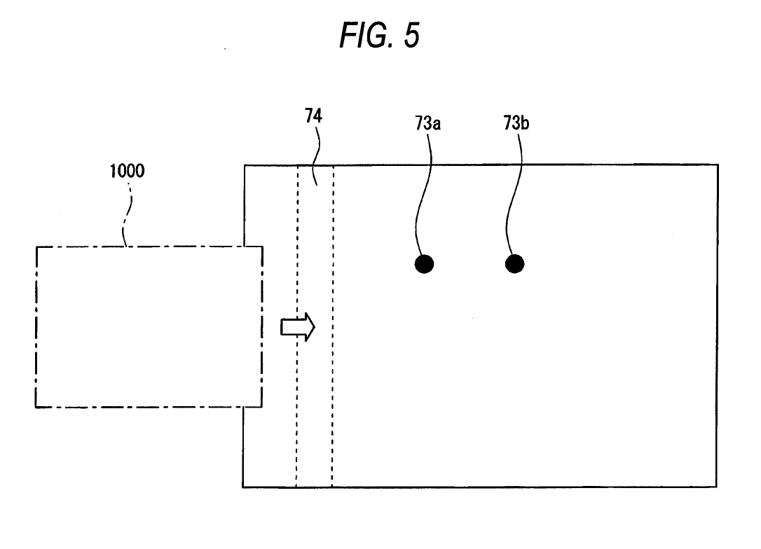

FIG. 5 is a plan view showing the arrangement of original detection sensors 73a and 73b which the scanner unit 70 includes. The original detection sensors 73a and 73b are arranged on the rear surface side of the first platen glass 71. These original detection sensors 73a and 73b are arranged so as to be arrayed in the sub scanning direction. They output detection signals to the system control portion 210. Besides, as shown in FIG. 5, the CCD image sensor 74 is arranged along the main scanning direction.

The processing unit 80 shown in FIGS. 2 and 3 processes an image signal obtained by the CCD image sensor 74. Concretely, the processing unit 80 converts the inputted image signal into image data (a digital signal). The image data are written into an image memory 81, and the processing unit 80 subjects the image data on the image memory 81, to various processes such as a shading correction and an offset correction. The processing unit 80 outputs the image data subjected to the various processes, to the image output control portion 203.

When the image output control portion 203 shown in FIGS. 1 and 2 has received the image data from the original read device 10 (processing unit 80), it forms an image on a paper sheet by an electrophotographic scheme on the basis of the image data. As shown in FIG. 1, therefore, the image formation unit 220 includes a photoconductor drum 221, an image write unit 222, a developing unit 223, a transfer roller 224, a separating and charging unit 225, a fixing unit 226 and a cleaner 227. Owing to such a configuration, the image formation unit 220 forms the image on the paper sheet as stated below.

After the photoconductor drum 221 has had its surface charged by a charging unit not shown, it is exposed to light by the image write unit 222 on the basis of the image data obtained by the image output control portion 210, whereby an electrostatic latent image is formed. On the other hand, a toner is supplied from a toner accommodation container not shown, into the developing unit 223, and it is stirred in the developing unit 223. The electrostatic latent image formed on the photoconductor drum 221 is developed through, for example, the developing roller of the developing unit 223, whereby a toner image is formed on the photoconductor drum 221. The toner image formed on the photoconductor drum 221 is transferred onto the paper sheet by a transfer portion which is configured in such a way that the transfer roller 224 touches the photoconductor drum 221, and it is heated and fixed by the fixing unit 226. In addition, the paper sheet onto which the toner image has been transferred is separated from the photoconductor drum 221 by the separating and charging unit 225. On the other hand, the residual toner which remains on the photoconductor drum 221 after the transfer is scraped off and recovered from on the photoconductor drum 221 by the cleaner 227.

Incidentally, as the image formation apparatus 1, not only one which forms a black-and-white image, but also one which forms a color image may apply this exemplary embodiment.

Besides, the image formation apparatus proper 200 includes paper-sheet accommodation portions 241, 242, 243 and 244 which are disposed on the lower side of this image formation apparatus proper 200. Each of the paper-sheet accommodation portions 241, 242, 243 and 244 defines a shape in which the bundle of paper sheets may be stacked. The paper-sheet accommodation portions 241, 242, 243 and 244 are arrayed in a vertical direction within the image formation apparatus proper 200, and they are respectively arranged so as to adjoin a paper-sheet transport path 251.

In forming an image, the paper sheets accommodated in the paper-sheet accommodation portions 241, 242, 243 and 244 are delivered to the paper-sheet transport path 251 one by one, and they are transported to registration rolls 253 on this side of the photoconductor drum 221 by transport rolls 252 arranged in the paper-sheet transport path 251. In addition, each paper sheet is supplied to the photoconductor drum 221 in synchronism with the operation of this photoconductor drum 221 by the registration rolls 253.

In addition, the paper sheet onto which a toner image has been transferred from the photoconductor drum 221 is transported to the fixing unit 226 by a transport belt 254. The toner image is fixed onto the paper sheet by heat and a pressure in the fixing unit 226. Further, the paper sheet is transported by ejection rolls 255 and is ejected into an ejection tray 260.

Besides, in forming images on both the sides of each paper sheet, the paper sheet formed with the image on one side thereof is not directly ejected into the ejection tray 260, but it is once transported to an inversion path 256 by switching the transport path. In addition, the paper sheet is transported from the inversion path 256 to a transport path 257, thereby to be inverted and to be supplied to the photoconductor drum 221. In addition, after the paper sheet has had the image copied onto its rear side, it is ejected into the ejection tray 260.

Next, the processes of the system control portion 210 will be described in detail.

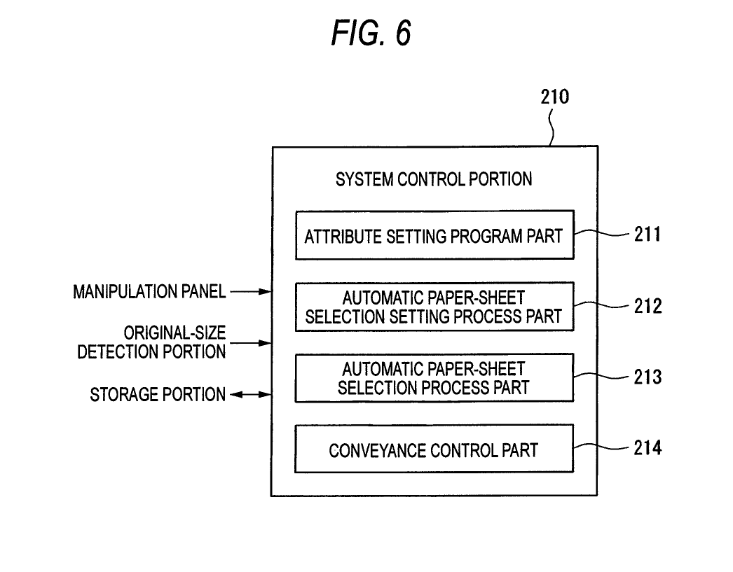

FIG. 6 is a block diagram showing the system control portion 210 functionally.

As shown in FIG. 6, the system control portion 210 includes an attribute setting process part 211, an automatic paper-sheet selection setting process part 212, an automatic paper-sheet selection process part 213 and a transport control part 214.

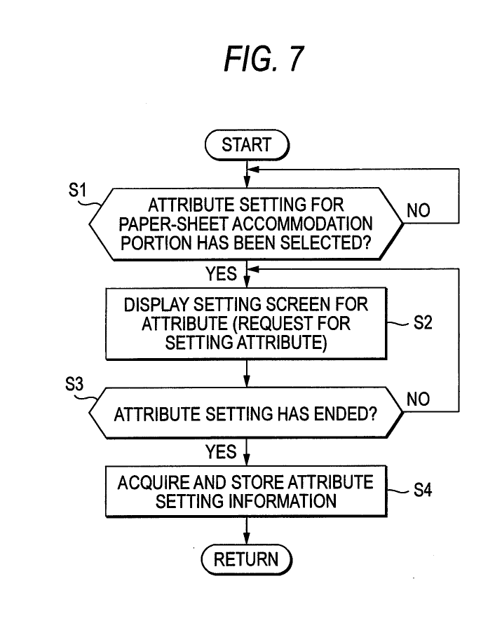

FIG. 7 is a flow chart showing the processing steps of the attribute setting process part 211.

As shown in FIG. 7, at the first step S1, the attribute setting process part 211 decides whether or not the attribute setting of the paper-sheet accommodation portion has been initiated. By way of example, the attribute setting process part 211 decides whether or not a manipulation for initiating the attribute setting of the paper-sheet accommodation portion has been made by the user, on the basis of input information from the manipulation panel 202. Subject to the decision that the attribute setting of the paper-sheet accommodation portion has been initiated, the attribute setting process part 211 proceeds to a step S2.

At the step S2, the attribute setting process part 211 displays an attribute setting screen on the display portion of the manipulation panel 202.

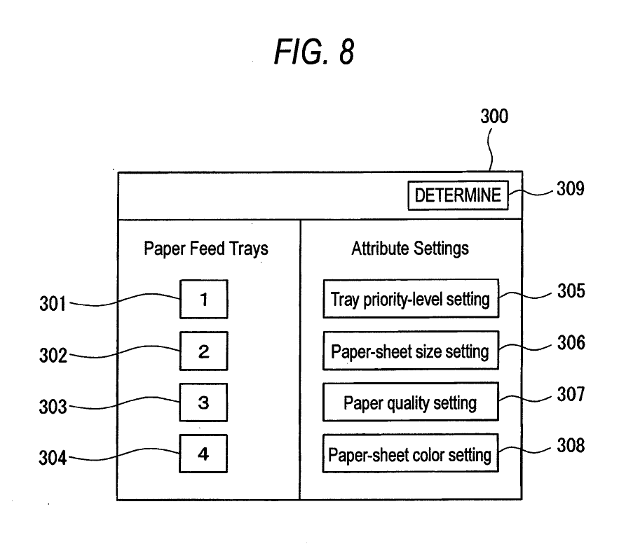

FIGS. 8 through 12 show display examples of the setting screen 300 for attributes. The setting steps of the attributes will be described with reference to FIGS. 8 through 12.

First, as shown in FIG. 8, in the attribute setting screen (main screen) 300, “1”, “2”, “3” and “4” (letters to which reference numerals 301 through 304 are respectively affixed) are indicated for “paper feed trays”, as ones representing the paper-sheet accommodation portions for which the attributes may be set (the Nos. of the paper-sheet accommodation portions). Besides, in the attribute setting screen 300, “tray priority-level setting”, “paper-sheet size setting”, “paper quality setting” and “paper-sheet color setting” (characters to which reference numerals 305 through 308 are respectively affixed) are indicated as ones representing those attributes of the paper-sheet accommodation portions which are set. Here, the “tray priority-level setting” serves to set the priority levels of the paper-sheet accommodation portions which are selected in an automatic paper-sheet selection function or an automatic paper-sheet selection mode (APS (Auto Paper Select)). Besides, the “paper quality setting” serves to set the paper qualities of the paper sheets which are accommodated in the paper-sheet accommodation portions. Besides, the “paper-sheet color setting” serves to set the colors of the paper sheets which are accommodated in the paper-sheet accommodation portions.

Owing to such an attribute setting screen 300, by way of example, the user selects “1” by manipulating the manipulation panel 202, thereafter selects the “tray priority-level setting” and thereafter selects “determine” (characters to which reference numeral 309 is affixed), whereby the priority level of the paper-sheet accommodation portion corresponding to “1” (the paper-sheet accommodation portion of, for example, the uppermost stage) may be set.

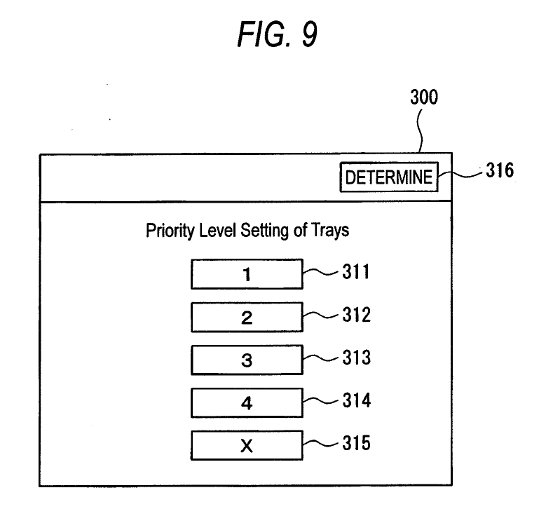

FIG. 9 shows an example of the setting screen 300 in the case where the “tray priority-level setting” has been selected.

As shown in FIG. 9, in this setting screen 300, “1”, “2”, “3”, “4” and “X” (letters to which reference numerals 311 through 315 are respectively affixed) are indicated as the priority levels which may be set as the attributes. Here, the priority levels become lower in the order of “1”, “2”, “3” and “4”. Besides, in a case where “X” has been set, the paper-sheet accommodation portion of this setting is prevented from being selected by the automatic paper-sheet selection function. That is, the paper-sheet accommodation portion for which “X” has been set becomes the paper-sheet accommodation portion which is inhibited from being selected, in the automatic paper-sheet selection function.

Owing to such a setting screen 300, by way of example, the user selects “1” by manipulating the manipulation panel 202 and thereafter selects “determine” (characters to which reference numeral 316 is affixed), whereby the priority level of the paper-sheet accommodation portion for which the attribute is to be set (the paper-sheet accommodation portion selected in the “paper feed trays”) may be set at the highest level.

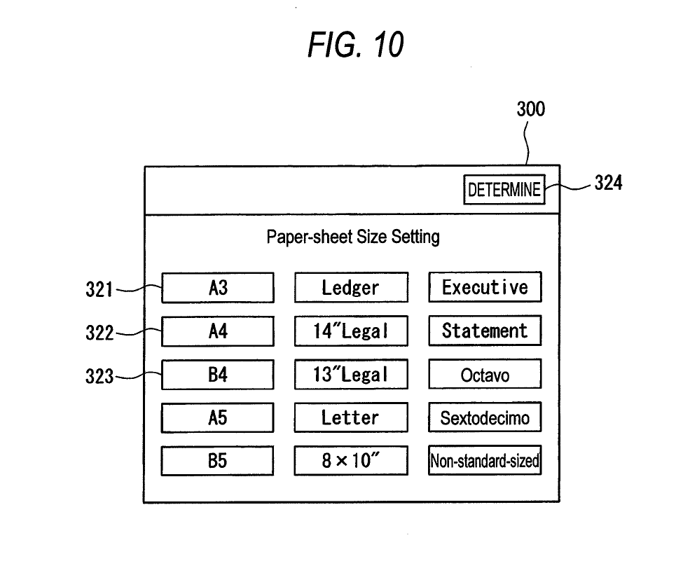

FIG. 10 shows an example of the setting screen 300 in the case where the “paper-sheet size setting” has been selected.

As shown in FIG. 10, in this setting screen 300, “A3”, “A4”, “B4” (letters to which reference numerals 321 through 323 are respectively affixed), are indicated as paper sheet sizes which may be set as attributes.

Owing to such a setting screen 300, by way of example, the user selects “A4” by manipulating the manipulation panel 202 and thereafter selects “determine” (characters to which reference numeral 324 is affixed), whereby the size of the paper sheets that are accommodated in the paper-sheet accommodation portion for which the attribute is to be set (the paper-sheet accommodation portion selected in the “paper feed trays”) may be set at “A4”.

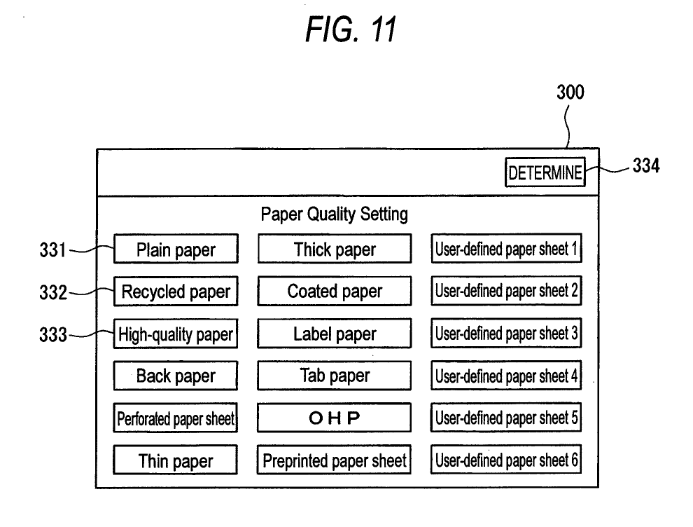

FIG. 11 shows an example of the setting screen 300 in the case where the “paper quality setting” has been selected.

As shown in FIG. 11, in this setting screen 300, “plain paper”, “recycled paper”, “high-quality paper” (characters to which reference numerals 331 through 333 are respectively affixed), are indicated as paper qualities which may be set as attributes.

Owing to such a setting screen 300, by way of example, the user selects the “plain paper” by manipulating the manipulation panel 202 and thereafter selects “determine” (characters to which reference numeral 334 is affixed), whereby the paper quality of the paper sheets that are accommodated in the paper-sheet accommodation portion for which the attribute is to be set (the paper-sheet accommodation portion selected in the “paper feed trays”) may be set at the plain paper.

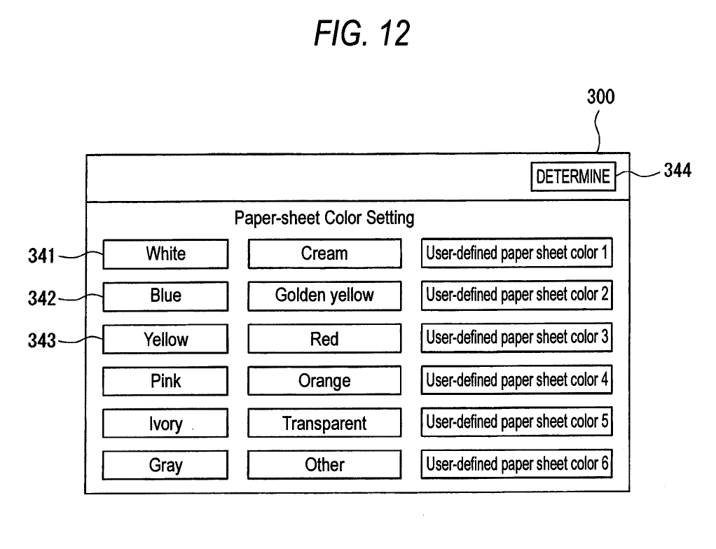

FIG. 12 shows an example of the setting screen 300 in the case where the “paper-sheet color setting” has been selected.

As shown in FIG. 12, in this setting screen 300, “white”, “blue”, “yellow” (characters to which reference numerals 341 through 343 are respectively affixed), are indicated as paper sheet colors which may be set as the attributes.

Owing to such a setting screen 300, by way of example, the user selects “white” by manipulating the manipulation panel 202 and thereafter selects “determine” (characters to which reference numeral 344 is affixed), whereby the color of the paper sheets that are accommodated in the paper-sheet accommodation portion for which the attribute is to be set (the paper-sheet accommodation portion selected in the “paper feed trays”) may be set at the white color.

In addition, at a step S3 in FIG. 7, the attribute setting process part 211 decides whether or not the setting of the attribute as stated above has ended. By way of example, the attribute setting process part 211 decides whether or not a manipulation for ending the attribute setting for the paper-sheet accommodation portion has been made by the user, on the basis of input information from the manipulation panel 202. Subject to the decision that the setting of the attribute has been ended, the attribute setting process part 211 proceeds to a step S4.

At the step S4, the attribute setting process part 211 acquires the setting information of the set attribute and stores the acquired setting information of the attribute in the storage portion 201. In addition, the attribute setting process part 211 ends the process shown in FIG. 7.

In the ensuing description, the information of the paper sheet size which has been set as the attribute of the paper-sheet accommodation portion by the above process shall be also termed the “attribute setting paper-sheet size”, while the information of that paper quality of the paper sheets which has been set as the attribute of the paper-sheet accommodation portion by the above process shall be also termed the “attribute setting paper quality”.

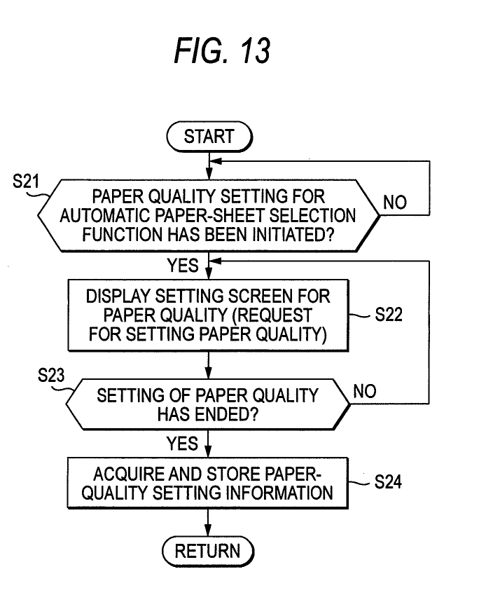

FIG. 13 is a flow chart showing the processing steps of the automatic paper-sheet selection setting process part 212.

As shown in FIG. 13, at the first step S21, the automatic paper-sheet selection setting process part 212 decides whether or not the paper quality setting for the automatic paper-sheet selection function has been initiated. By way of example, the automatic paper-sheet selection setting process part 212 decides whether or not a manipulation for performing the paper quality setting for the automatic paper-sheet selection function (the setting of the paper quality to be handled in the automatic paper-sheet selection function) has been made by the user, on the basis of input information from the manipulation panel 202. Subject to the decision that the paper quality setting for the automatic paper-sheet selection function has been initiated, the automatic paper-sheet selection setting process part 212 proceeds to a step S22.

At the step S22, the automatic paper-sheet selection setting process part 212 indicates the setting screen for that paper quality of the paper sheets which may be selected in the automatic paper-sheet selection function, on the display portion of the manipulation panel 202. Thus, the user may set that paper quality of the paper sheets which is selected in the automatic paper-sheet selection function, at the “plain paper”, the “recycled paper” or the like by manipulating the manipulation panel 202.

At the subsequent step S23, the automatic paper-sheet selection setting process part 212 decides whether or not the setting of the paper quality has ended. By way of example, the automatic paper-sheet selection setting process part 212 decides whether or not a manipulation for ending the setting of the paper quality has been made by the user, on the basis of input information from the manipulation panel 202. Subject to the decision that the setting of the paper quality has ended, the automatic paper-sheet selection setting process part 212 proceeds to a step S24.

At the step S24, the automatic paper-sheet selection setting process part 212 acquires the information of the set paper quality and stores the acquired information of the paper quality in the storage portion 201. In addition, the automatic paper-sheet selection setting process part 212 ends the process shown in FIG. 13.

By way of example, the paper quality setting for the automatic paper-sheet selection function as stated above may be performed each time the image formation apparatus 1 is initially set or each time the original is copied.

In the ensuing description, the paper quality which has been set for the automatic paper-sheet selection function by the above process shall also be termed the “automatic paper-sheet selection setting paper-quality”.

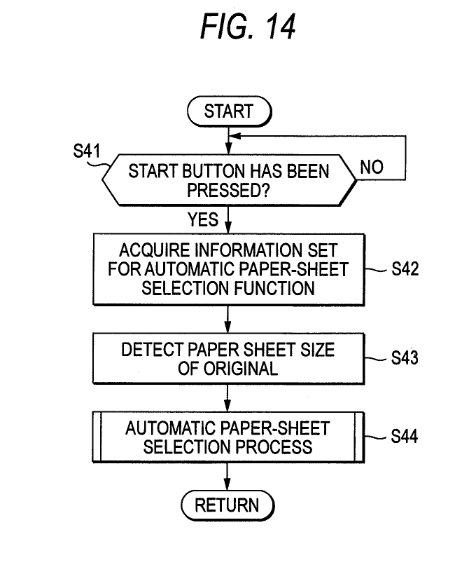

FIG. 14 is a flow chart showing the processing steps of the automatic paper-sheet selection process part 213.

As shown in FIG. 14, at the first step S41, the automatic paper-sheet selection process part 213 decides whether or not a start button for copying the original has been pressed, on the basis of input information from the manipulation panel 202. Subject to the decision that the start button for copying the original has been pressed, the automatic paper-sheet selection process part 213 proceeds to a step S42.

At the step S42, the automatic paper-sheet selection process part 213 acquires information set for the automatic paper-sheet selection function. That is, the automatic paper-sheet selection process part 213 acquires the automatic paper-sheet selection setting paper-quality which the automatic paper-sheet selection setting process part 212 has stored in the storage portion 201, in the process shown in FIG. 13. Further, the automatic paper-sheet selection process part 213 acquires the information of the copying magnifications of the original, on the basis of input information from the manipulation panel 202.

At the subsequent step S43, the automatic paper-sheet selection process part 213 detects the paper sheet size of the original.

Concretely, when the original is copied by reading the image of the original put on the first platen glass 71 shown in FIG. 3, the automatic paper-sheet selection process part 213 detects the length of the original in the main scanning direction (the width of the original), on the basis of the detection signal of the CCD image sensor 74 shown in FIG. 5. By way of example, the length of the original in the main scanning direction may be detected in units of 1 mm, from the ON and OFF states of the CCD image sensor 74. Besides, on this occasion, the automatic paper-sheet selection process part 213 detects the length of the original in the sub scanning direction (the length of the original), on the basis of the ON and OFF states of the sensors as have been obtained from the detection signals of the original detection sensors 73a and 73b.

Besides, when the original is copied by reading the image of the original through the second platen glass 72 shown in FIG. 3, that is, when the original is copied by reading the image of the original in accordance with the automatic original feed, the automatic paper-sheet selection process part 213 detects the length of the original in the main scanning direction (the width of the original), on the basis of the ON and OFF states of the sensors as have been obtained from the detection signals of the guide-member movement sensors 61a, 61b and 61c and the transported-original detection sensors 63a, 63b and 63c shown in FIG. 4. Besides, on this occasion, the automatic paper-sheet selection process part 213 obtains the passing times of the front end and rear end of the original which is transported and controlled along the first transport path 41, on the basis of the detection signals of transported-original detection sensors 62a, 62b and 62c, thereby to detect the length of the original in the sub scanning direction (the length of the original) on the basis of the passing times.

Besides, when the images of the originals of different sizes are read and copied on the second platen glass 72, that is, when the operation is in a mode for copying the originals of mixed sizes, the automatic paper-sheet selection process part 213 detects the length of the original in the main scanning direction (the width of the original), on the basis of the ON and OFF states (the combination thereof) of the transported-original detection sensors 63a, 63b and 63c. At the subsequent step S44, the automatic paper-sheet selection process part 213 executes an automatic paper-sheet selection process for the automatic paper-sheet selection function.

Here, the “automatic paper-sheet selection function” is the function of selecting as the paper-sheet accommodation portion which is employed for the image formation, the paper-sheet accommodation portion which accommodates therein the paper sheets that have a size selected on the basis of the paper sheet size of the read original and the copying magnifications of the original and that satisfy the paper quality of the paper sheets set as information beforehand (automatic paper-sheet selection setting paper-quality).

With such an automatic paper-sheet selection process, however, when the paper sheets of the paper quality set for the automatic paper-sheet selection function beforehand do not exist as the accommodated paper sheets of the paper-sheet accommodation portions 241, 242, 243 and 244, a selection process for the paper sheets cannot be executed, and hence, the copying of the original will fail to start. In this case, a control command sent from host control means will be suspended.

On the other hand, even in a case where the paper sheets of the paper quality set for the automatic paper-sheet selection function beforehand do not exist in the accommodated paper sheets of the paper-sheet accommodation portions 241, 242, 243 and 244, some users might want to execute the copying by using the existent accommodated paper sheets of the paper-sheet accommodation portion 241, 242, 243 or 244.

For such a reason, there will now be described a scheme in which, even in the case where the paper sheets of the paper quality set for the automatic paper-sheet selection function beforehand (automatic paper-sheet selection setting paper-quality) do not exist in the accommodated paper sheets of the paper-sheet accommodation portions 241, 242, 243 and 244, the selection of paper sheets based on the automatic paper-sheet selection function is permitted to make the copying executable.

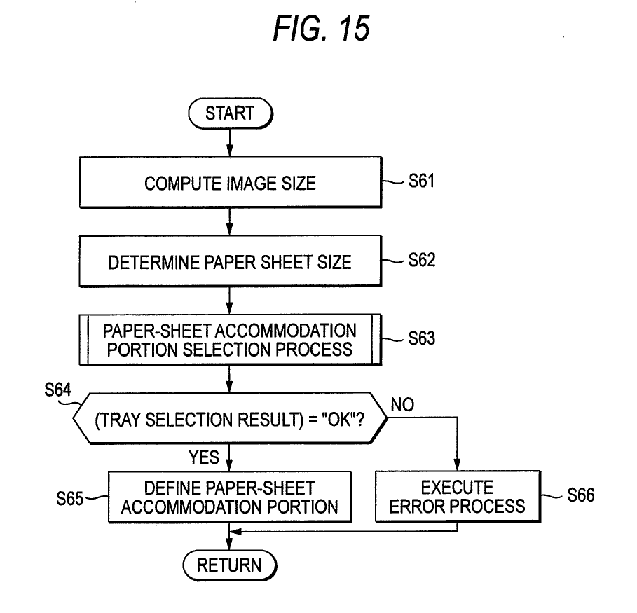

FIG. 15 shows a flow chart of a process which permits such selection of the paper sheets based on the automatic paper-sheet selection function. This process becomes the subroutine of the above step S44.

As shown in FIG. 15, at the first step S61, the automatic paper-sheet selection process part 213 computes an image size. That is, the automatic paper-sheet selection process part 213 calculates the image size on the basis of the information of the copying magnifications of the original as acquired at the step S42 and the paper sheet size of the original as detected at the step S43 (for example, the image size=the copying magnifications×the paper sheet size of the original).

At the subsequent step S62, the automatic paper-sheet selection process part 213 selects the paper sheet size of the paper sheet which is used for the copying. Concretely, the automatic paper-sheet selection process part 213 selects as the paper sheet size, the smallest standard size among the sizes in which the image size calculated at the step S61 may be contained.

At the subsequent step S63, the automatic paper-sheet selection process part 213 executes the paper-sheet accommodation portion selection process.

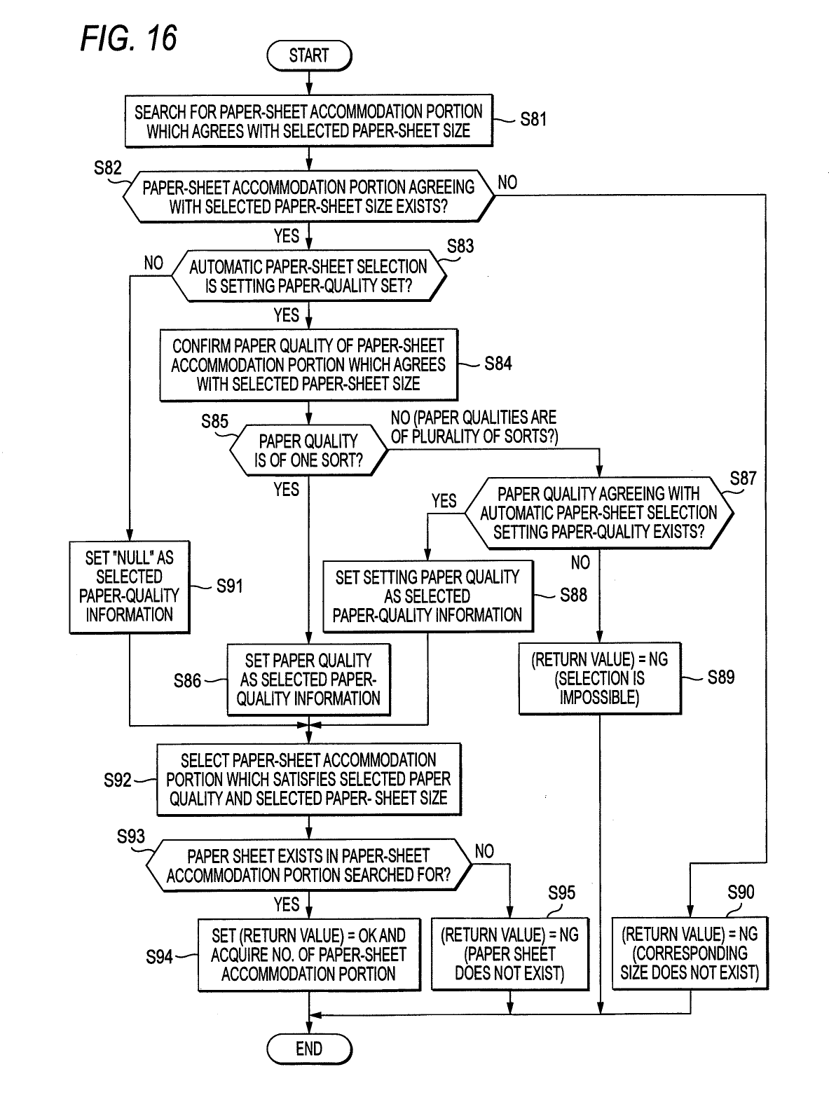

FIG. 16 is a flow chart showing the subroutine of the step S63.

As shown in FIG. 16, at the first step S81, the automatic paper-sheet selection process part 213 searches for the paper-sheet accommodation portion which agrees with the corresponding paper-sheet size. Here, the “corresponding paper-sheet size” is the paper sheet size selected at the step S62 (hereinbelow, termed the “selected paper-sheet size”). For such a purpose, at this step S81, the automatic paper-sheet selection process part 213 searches for the paper-sheet accommodation portion for which the attribute setting paper-sheet size that agrees with the selected paper-sheet size is set, on the basis of those setting information items of the attributes of the paper-sheet accommodation portions which are stored in the storage portion 201.

At the subsequent step S82, the automatic paper-sheet selection process part 213 decides whether or not the paper-sheet accommodation portion which agrees with the selected paper-sheet size exists, on the basis of the search result of the step S81. Subject to the decision that the paper-sheet accommodation portion which agrees with the selected paper-sheet size exists, that is, in case of the existence of the paper-sheet accommodation portion for which the attribute setting paper-sheet size that agrees with the selected paper-sheet size is set, the automatic paper-sheet selection process part 213 proceeds to a step S83. On the other hand, subject to the decision that the paper-sheet accommodation portion which agrees with the selected paper-sheet size does not exist, the automatic paper-sheet selection process part 213 proceeds to a step S90.

At the step S90, the automatic paper-sheet selection process part 213 sets “NG” as a return value (tray selection result) because of the nonexistence of the paper-sheet accommodation portion which agrees with the selected paper-sheet size. Further, the automatic paper-sheet selection process part 213 sets the sort of the reason why “NG” has been set as the return value. By way of example, “1” is set as a flag NGFLG (NGFLG=1). In addition, the automatic paper-sheet selection process part 213 ends the process of FIG. 16 (the step S63).

At the step S83, the automatic paper-sheet selection process part 213 decides whether or not the automatic paper-sheet selection setting paper quality is set. That is, the automatic paper-sheet selection process part 213 decides whether or not the automatic paper-sheet selection setting paper quality is stored in the storage portion 201. Subject to the decision that the automatic paper-sheet selection setting paper quality is set, the automatic paper-sheet selection process part 213 proceeds to a step S84. On the other hand, subject to the decision that the automatic paper-sheet selection setting paper quality is not set, the automatic paper-sheet selection process part 213 proceeds to a step S91.

At the step S91, the automatic paper-sheet selection process part 213 sets “Null” as selected paper quality information (it sets the fact that the paper quality setting is not made). In addition, the automatic paper-sheet selection process part 213 proceeds to a step S92.

At the step S84, the automatic paper-sheet selection process part 213 confirms the paper quality of the paper-sheet accommodation portion which agrees with the selected paper-sheet size. Concretely, the automatic paper-sheet selection process part 213 confirms the attribute setting paper-quality stored in the storage portion 201.

At the subsequent step S85, the automatic paper-sheet selection process part 213 decides whether or not the sort of the paper quality is one, on the basis of the processed result of the step S84. That is, the automatic paper-sheet selection process part 213 decides whether or not only one attribute setting paper-quality is set as to all the paper-sheet accommodation portions which agree with the selected paper-sheet size. Subject to the decision that the sort of the paper quality is one, the automatic paper-sheet selection process part 213 proceeds to a step S86. On the other hand, subject to the decision that a plurality of sorts are set as the paper qualities, the automatic paper-sheet selection process part 213 proceeds to a step S87.

At the step S86, the automatic paper-sheet selection process part 213 sets the paper quality of one sort as the selected paper-quality information. That is, the automatic paper-sheet selection process part 213 sets as the selected paper-quality information, the attribute setting paper-quality in the case where it has been decided at the step S85 that only one attribute setting paper-quality is set. In addition, the automatic paper-sheet selection process part 213 proceeds to the step S92.

At the step S87, the automatic paper-sheet selection process part 213 decides whether or not the paper quality which agrees with the automatic paper-sheet selection setting paper-quality exists. That is, the automatic paper-sheet selection process part 213 decides whether or not the paper sheet agreeing with the automatic paper-sheet selection setting paper-quality exists in the plurality of attribute setting paper-qualities in the case where it has been decided at the step S85 that the plurality of sorts exist. Subject to the decision that the paper quality agreeing with the automatic paper-sheet selection setting paper-quality exists, the automatic paper-sheet selection process part 213 proceeds to a step S88. On the other hand, subject to the decision that the paper quality agreeing with the automatic paper-sheet selection setting paper-quality does not exist, the automatic paper-sheet selection process part 213 proceeds to a step S89. That is, when any of the plurality of attribute setting paper-qualities does not agree with the automatic paper-sheet selection setting paper-quality, the automatic paper-sheet selection process part 213 proceeds to the step S89.

At the step S88, the automatic paper-sheet selection process part 213 sets the automatic paper-sheet selection setting paper-quality as the selected paper-quality information. In addition, the automatic paper-sheet selection process part 213 proceeds to the step S92.

At the step S89, the automatic paper-sheet selection process part 213 sets “NG” as a return value, upon deciding that any paper sheet cannot be selected by the automatic paper-sheet selection function because any of the plurality of attribute setting paper qualities does not agree with the automatic paper-sheet selection setting paper-quality. Further, the automatic paper-sheet selection process part 213 sets the sort of the reason why “NG” has been set as the return value. By way of example, “2” is set as the flag NGFLG (NGFLG=2). In addition, the automatic paper-sheet selection process part 213 ends the process of FIG. 16 (the step S63).

At the step S92, the automatic paper-sheet selection process part 213 searches for and selects the paper-sheet accommodation portion which satisfies the selected paper quality and the selected paper-sheet size that have been set at any of the steps S86, S88 and S91.

By way of example, in the case where “Null” is set as the selected paper-quality information by the process of the step S91, and where the plurality of paper-sheet accommodation portions agreeing with the selected paper-sheet size exist, the paper-sheet accommodation portion of higher priority level is selected on the basis of the information items of the priority levels which are set as the attributes of the paper-sheet accommodation portions.

At the subsequent step S93, the automatic paper-sheet selection process part 213 decides whether or not the paper sheet exists in the paper-sheet accommodation portion selected at the step S92. In a case where the paper sheet exists, the automatic paper-sheet selection process part 213 proceeds to a step S94. On the other hand, in a case where the paper sheet does not exist, the automatic paper-sheet selection process part 213 proceeds to a step S95.

At the step S94, the automatic paper-sheet selection process part 213 sets “OK” as a return value, and it acquires the No. of the paper-sheet accommodation portion which satisfies the conditions of the steps S92 and S93. In addition, the automatic paper-sheet selection process part 213 ends the process of FIG. 16 (the step S63).

At the step S95, the automatic paper-sheet selection process part 213 sets “NG” as a return value because the paper sheet does not exist in the paper-sheet accommodation portion selected by the automatic paper-sheet selection function. Further, the automatic paper-sheet selection process part 213 sets the sort of the reason why “NG” has been set as the return value. By way of example, “3” is set as the flag NGFLG (NGFLG=3). In addition, the automatic paper-sheet selection process part 213 ends the process of FIG. 16 (the step S63).

The above is the process of the step S63 in FIG. 15.

At the subsequent step S64 in FIG. 15, the automatic paper-sheet selection process part 213 decides whether or not the tray selection result (return value) set at the step S63 is “OK”. Subject to the decision that the tray selection result is “OK”, the automatic paper-sheet selection process part 213 proceeds to a step S65. On the other hand, subject to the decision that the tray selection result (return value) is “NG”, the automatic paper-sheet selection process part 213 proceeds to a step S66.

At the subsequent step S65, the automatic paper-sheet selection process part 213 defines the paper-sheet accommodation portion which is selected by the automatic paper-sheet selection function. That is, the automatic paper-sheet selection process part 213 defines the paper-sheet accommodation portion of the No. acquired at the step S94, as the paper-sheet accommodation portion which is selected by the automatic paper-sheet selection function. In addition, the automatic paper-sheet selection process part 213 ends the process of FIG. 15 (the step S44).

At the step S66, the automatic paper-sheet selection process part 213 executes an error process. Concretely, the automatic paper-sheet selection process part 213 presents an error display on the display portion of the manipulation panel 202. On this occasion, the automatic paper-sheet selection process part 213 presents the error display corresponding to the cause by which the tray selection result has become “NG” (flag NGFLG). By way of example, in the case where the process of the step S90 has been executed (the case where the corresponding paper-sheet size does not exist, and where NGFLG=1 holds), the automatic paper-sheet selection process part 213 indicates on the display portion of the manipulation panel 202, an instruction for letting the user select the paper-sheet accommodation portion. Besides, in the case where the process of the step S89 has been executed (the case where the paper-sheet accommodation portion cannot be selected by the automatic paper-sheet selection function, and where NGFLG=2 holds), the automatic paper-sheet selection process part 213 indicates on the display portion of the manipulation panel 202, an instruction for letting the user select the paper-sheet accommodation portion. Further, in the case where the process of the step S95 has been executed (the case where the paper sheet does not exist in the paper-sheet accommodation portion selected by the automatic paper-sheet selection function, and where NGFLG=3 holds), the automatic paper-sheet selection process part 213 indicates on the display portion of the manipulation panel 202, an instruction for letting the user replenish the corresponding paper-sheet accommodation portion with the paper sheets. In addition, the automatic paper-sheet selection process part 213 ends the process of FIG. 15 (the step S44).

The above is the process of the automatic paper-sheet selection process part 213.

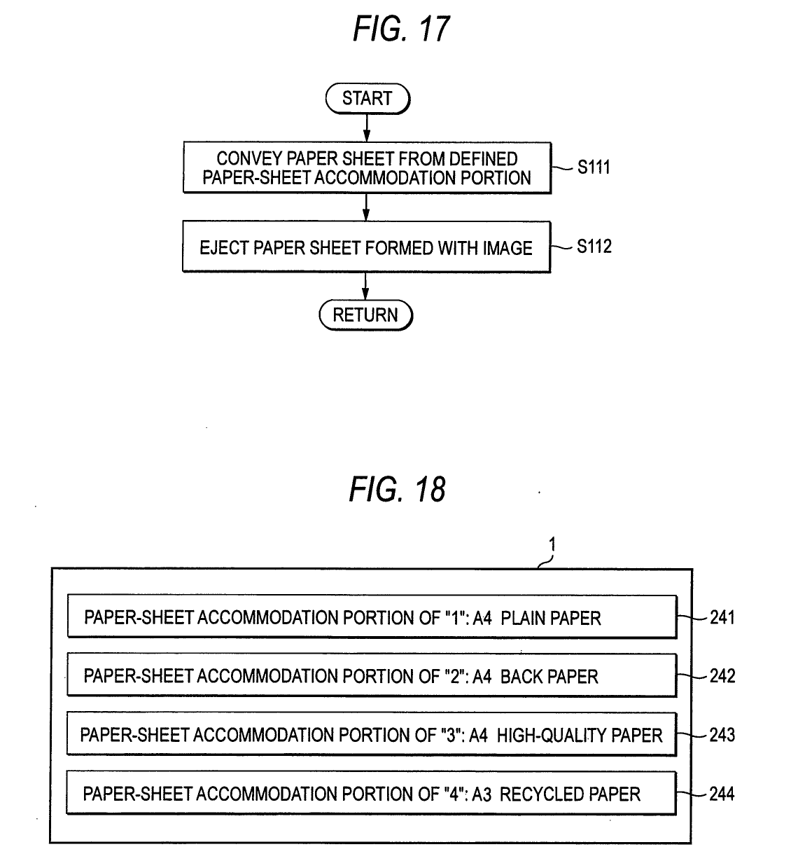

FIG. 17 is a flow chart showing the processing steps of the transport control part 214.

As shown in FIG. 17, at the first step S111, the transport control part 214 drives and controls the transport rolls 252, etc., thereby to transport the paper sheet from the paper-sheet accommodation portion defined by the automatic paper-sheet selection process part 213, to the image formation unit 220. In addition, at a step S112, the transport control part 214 drives and controls the ejection rolls 255, thereby to eject into the ejection tray 260, the paper sheet which has been formed with an image by the image formation unit 220.

An operation in the case where the original is copied in the image formation apparatus 1 as stated above, becomes as described below.

When the original is put on the original supply portion 21, and the start button of the manipulation panel 202 is pressed by the user, the original read device 10 reads the image of the original in a case where the original is put on the first platen glass 71. In addition, the original read device 10 subjects read and acquired image data to various processes by the processing unit 80. The original read device 10 outputs the processed image data to the image output control portion 203.

Besides, in a case where the original is put on the original supply portion 21, the original read device 10 starts the read of the original. Thus, the original read device 10 sends the originals put on the original supply portion 21, to the second platen glass 72 of the scanner unit 70, one by one, so as to read the images of the originals by the scanner unit 70. In addition, the original read device 10 subjects the read and acquired image data to various processes by the processing unit 80. The original read device 10 outputs the processed image data to the image output control portion 203 in succession.

On the other hand, the automatic paper-sheet selection process part 213 acquires the various information items such as the automatic paper-sheet selection setting paper-quality, the copying magnifications of the original, and the paper sheet size of the original (the steps S41, S42 and S43). In addition, the automatic paper-sheet selection process part 213 calculates the image size on the basis of the copying magnifications of the original and the paper sheet size of the original, and it selects the paper sheet size of the standard size from the calculated image size (the steps S61 and S62).

In addition, the automatic paper-sheet selection process part 213 executes various processes as stated below, on the basis of the existence or nonexistence of the paper-sheet accommodation portion which agrees with the selected paper-sheet size, the existence or nonexistence of the setting of the automatic paper-sheet selection setting paper-quality, the attribute setting paper-quality, etc.

When the paper-sheet accommodation portion agreeing with the selected paper-sheet size does not exist, the automatic paper-sheet selection process part 213 sets “NG” as the return value (the steps S82 and S90).

Besides, when the paper-sheet accommodation portion agreeing with the selected paper-sheet size exists, the setting of the automatic paper-sheet selection setting paper-quality exists, and the attribute setting paper-quality of the paper-sheet accommodation portion agreeing with the selected paper sheet size is of one sort, the automatic paper-sheet selection process part 213 sets the paper quality (the attribute setting paper-quality of one sort) as the selected paper-quality information (the steps S82, S83, S84, S85 and S86).

Besides, when the paper-sheet accommodation portion agreeing with the selected paper-sheet size exists, the setting of the automatic paper-sheet selection setting paper-quality exists, and the attribute setting paper-qualities of the paper-sheet accommodation portions agreeing with the selected paper sheet size are of the plurality of sorts, the automatic paper-sheet selection process part 213 sets the agreeing paper quality (automatic paper-sheet selection setting paper-quality) as the selected paper-quality information, only in a case where any of the plurality of sorts of paper qualities agrees with the automatic paper-sheet selection setting paper-quality (the steps S82, S83, S84, S85, S87 and S88). Besides, when the automatic paper-sheet selection setting paper-quality does not agree with any of the plurality of sorts of paper qualities in this case, the automatic paper-sheet selection process part 213 sets “NG” as the return value (the steps S82, S83, S84, S85, S87 and S89).

Besides, when the setting of the automatic paper-sheet selection setting paper-quality does not exist in spite of the existence of the paper-sheet accommodation portion agreeing with the selected paper-sheet size, the automatic paper-sheet selection process part 213 sets “Null” as the selected paper-quality information (the steps S82, S83 and S91).

In addition, when the paper-sheet accommodation portion which satisfies the selected paper quality and the selected paper-sheet size exists and the paper sheet exists in the paper-sheet accommodation portion, in the case where the selected paper-quality information as stated above has been set, the automatic paper-sheet selection process part 213 sets “OK” as the return value and acquires the No. of the paper-sheet accommodation portion (the steps S92, S93 and S94). On the other hand, when the paper sheet does not exist in the paper-sheet accommodation portion, the automatic paper-sheet selection process part 213 sets “NG” as the return value (the steps S92, S93 and S95).

In addition, in the case where the automatic paper-sheet selection process part 213 has set “NG” as the tray selection result (return value), it presents the error display corresponding to the cause by which the tray selection result has become “NG” (the flag NGFLG) (the steps S64 and S66).

On the other hand, in the case where the automatic paper-sheet selection process part 213 has set “OK” as the tray selection result (return value), it defines the No. of the paper-sheet accommodation portion as one which is to be selected by the automatic paper-sheet selection function (the steps S64 and S65). Thus, the transport control part 214 drives and controls the transport rolls 252, etc., thereby to transport the paper sheet from the paper-sheet accommodation portion defined by the automatic paper-sheet selection process part 213, to the image formation unit 220 (the step S111).

In addition, the image output control portion 203 controls the image formation unit 220 on the basis of the image data, so as to form the image on the paper sheet. Besides, the transport control part 214 drives and controls the ejection rolls 255, thereby to eject into the ejection tray 260, the paper sheet which has been formed with the image by the image formation unit 220 (the step S112).

Here, an operation based on a practicable example will be described with reference to FIG. 18.

As shown in FIG. 18, it is assumed that the paper sheet size of “A4” and the paper quality of “plain paper” are respectively set as attributes for the paper-sheet accommodation portion 241 of No. “1”. It is also assumed that the paper sheet size of “A4” and the paper quality of “back paper” are respectively set as attributes for the paper-sheet accommodation portion 242 of No. “2”. Besides, it is assumed that the paper sheet size of “A4” and the paper quality of “high-quality paper” are respectively set as attributes for the paper-sheet accommodation portion 243 of No. “3”. Further, it is assumed that the paper sheet size of “A3” and the paper quality of “recycled paper” are respectively set as attributes for the paper-sheet accommodation portion 244 of No. “4”. Incidentally, it is assumed that “x” is not set in the setting of tray priority levels for all the paper-sheet accommodation portions 241, 242, 243 and 244, and that all may be selected in accordance with certain priority levels in the automatic paper-sheet selection function.

In the case where the attributes are set in this manner and where the “plain paper” is set as the automatic paper-sheet selection setting paper-quality, the paper-sheet accommodation portion 241 of “1” is selected when the selected paper-sheet size has become the paper sheet size of “A4” in the automatic paper-sheet selection function (the steps S88 and S65).

Besides, in the case where the attributes are set in this manner and where the setting of the automatic paper-sheet selection setting paper-quality is not made, the paper-sheet accommodation portion is selected in accordance with the tray priority levels set as the attributes, when the selected paper-sheet size has become the paper sheet size of “A4” in the automatic paper-sheet selection function (the steps S91, S92 and S65).

Besides, in the case where the attributes are set in this manner and where any paper quality other than the “plain paper”, “back paper” and “high-quality paper” is set as the automatic paper-sheet selection setting paper-quality, the error process is executed when the selected paper-sheet size has become the paper sheet size of “A4” in the automatic paper-sheet selection function (the steps S89 and S66).

Further, in the case where the attributes are set in this manner and where the “plain paper” is set as the automatic paper-sheet selection setting paper-quality, the paper-sheet accommodation portion 244 of “4” is selected in spite of the disagreement between the automatic paper-sheet selection setting paper-quality and the attribute setting paper-quality when the selected paper-sheet size has become the paper sheet size of “A3” in the automatic paper-sheet selection function (the steps S86 and S65).

Here, let's consider the case of the mixed-size original copying mode in which the paper sheet size of “A4” and the paper sheet size of “A3” are selected in the automatic paper-sheet selection function.

Even in this case where the “plain paper” is set as the automatic paper-sheet selection setting paper-quality, the paper-sheet accommodation portion 241 of “1” is selected when the selected paper-sheet size has become the paper sheet size of “A4” in the automatic paper-sheet selection function. In addition, when the selected paper-sheet size has been switched to the paper sheet size of “A3” in the automatic paper-sheet selection function, the paper-sheet accommodation portion 244 of “4” is selected.

By way of example, it is generally and often the case that, in the image formation apparatus, the paper sheets of the plurality of sorts of paper qualities are accommodated in the plurality of paper-sheet accommodation portions, as to the paper sheet size of “A4” whose frequency in use is high, whereas the paper sheets of one sort of paper quality, such as the “recycled paper”, are accommodated in one paper-sheet accommodation portion, as to the paper sheet size of “A3” whose frequency in use is low.

In this exemplary embodiment, even under such a situation, the paper sheets of the paper-sheet accommodation portion in which the paper sheet size of “A3” is accommodated are selected in the automatic paper-sheet selection function, in the case where the paper quality of the paper sheets of the paper-sheet accommodation portion in which the paper sheet size of “A3” is accommodated is not set as the automatic paper-sheet selection setting paper-quality. Thus, even in the mixed-size original copying mode, the execution of a printing request is not interrupted at the stage of copying with the paper sheet size of “A3”, and printing may be completed in compliance with the printing request.

As stated before, in this exemplary embodiment, the image formation apparatus 1 has the automatic paper-sheet selection function of selecting the paper-sheet accommodation portion which accommodates therein the paper sheets having the attribute setting paper-sheet size that corresponds to the selected paper-sheet size, selected on the basis of the copying magnifications and the paper sheet size of the original, and the attribute setting paper-quality that corresponds to the automatic paper-sheet selection setting paper-quality. Besides, in the case where the attribute setting paper-quality as to the paper-sheet accommodation portion which may be selected by the automatic paper-sheet selection function is of the single sort, the image formation apparatus 1 selects the paper-sheet accommodation portion which accommodates therein the printing media having the attribute setting paper-quality of the single sort and the attribute setting paper-sheet size that corresponds to the selected paper-sheet size, even when the automatic paper-sheet selection setting paper-quality does not correspond to the single sort in the automatic paper-sheet selection function (the steps S86 and S65). That is, the paper-sheet accommodation portion in which the paper sheets of the attribute setting paper-quality of the single sort are accommodated is selected without regard to the agreement and disagreement between the single sort and the sort of the automatic paper-sheet selection setting paper-quality.

Thus, even in the case where the paper quality of the paper sheets previously set for the automatic paper-sheet selection function (automatic paper-sheet selection setting paper-sheet) does not exist in the paper sheets of the paper-sheet accommodation portion which may be selected by the automatic paper-sheet selection function, the image formation apparatus 1 may select one paper-sheet accommodation portion by the automatic paper-sheet selection function.

As a result, the image formation apparatus 1 may select the paper sheets which will be more intended by the user, by the automatic paper-sheet selection function.

Besides, in this exemplary embodiment, in the case where the paper-sheet accommodation portions which may be selected by the automatic paper-sheet selection function accommodate therein the plurality of sorts of printing media as to the attribute setting paper-sheet size corresponding to the selected paper-sheet size and where the automatic paper-sheet selection setting paper-quality does not correspond to any of the plurality of sorts, the image formation apparatus 1 sets “NG” as the return value, thereby to avoid the selection of the paper-sheet accommodation portions in the automatic paper-sheet selection function (the steps S89 and S66).

Thus, the image formation apparatus 1 prevents the paper sheet which is not intended by the user, from being selected by the automatic paper-sheet selection function.

By the way, in this exemplary embodiment, the original read device 10 is employed as acquisition means. Besides, the paper-sheet accommodation portions 241, 242, 243 and 244 are employed as a plurality of accommodation means. Besides, the manipulation panel 202 and the attribute setting process part 211 are employed as accommodated-printing-medium setting means. Further, the manipulation panel 202 and the automatic paper-sheet selection setting process part 212 are employed as selected-printing-medium setting means. Still further, the automatic paper-sheet selection process part 213 (especially, the process of the step S62) is employed as determination means. Yet further, the automatic paper-sheet selection process part 213 is employed as selection means. In addition, the image output control portion 203 and the image formation unit 220 are employed as image formation means.

Besides, configurations to be stated below are mentioned as modifications to this exemplary embodiment.

In this exemplary embodiment, set images in practicable aspects are shown in FIGS. 8 through 12. Needless to say, however, set screens are not restricted to these aspects.

Besides, in this exemplary embodiment, the paper-sheet accommodation portion is selected with note taken of the paper quality of the paper sheet (refer to FIG. 16). In the modification to the exemplary embodiment, however, the paper-sheet accommodation portion may be selected by replacing the information of the paper quality of the paper sheet with the information of any other than the paper quality of the paper sheet (for example, the color of the paper sheet) or the combination between the information of the paper quality of the paper sheet and another information on the paper sheet (for example, the color of the paper sheet), for example, the information of the sort of the paper sheet.

By way of example, in the case where the paper-sheet accommodation portion is selected on the basis of the sort of the paper sheet as consists of the combination between the information of the paper quality of the paper sheet and the information of the paper-sheet color, the sort of the paper sheet of the paper-sheet accommodation portion agreeing with the selected paper-sheet size is set as the selected paper-sheet information (the step S86) when the sort of the paper sheet of the pertinent paper-sheet accommodation portion is one sort (the combination between the information of the paper quality of the paper sheet and the information of the paper-sheet color is of one sort). Besides, when the paper sheets of the paper-sheet accommodation portions agreeing with the selected paper-sheet size are of a plurality of sorts (the combinations between the information of the paper quality of the paper sheet and the information of the paper-sheet color are of a plurality of sorts, and any of the plurality of sorts agrees with the sort of the paper sheet set for the automatic paper-sheet selection (the combination between the information of the paper quality of the paper sheet and the information of the paper-sheet color), the sort of the set paper sheet is set as the selected paper-sheet information (the step S88).

Besides, in the modification to this exemplary embodiment, the information of the sort of the paper sheet may be made information indicating the weight of the paper sheet, namely, the information of the so-called weighing of the paper sheet. More specifically, the information of the paper quality of the paper sheet in the foregoing description of the exemplary embodiment may be replaced with the information of the weighing, or the information of the paper sheet may be made the combination among the information of the paper quality of the paper sheet, the information of the paper-sheet color and the information of the weighing of the paper sheet.

Further, in this exemplary embodiment, the image is formed by the electrophotographic scheme. In contrast, in the modification to this exemplary embodiment, an image may be formed by another printing scheme such as an inkjet recording scheme.

Besides, the control program of a computer capable of incarnating the various processes as stated before can, of course, be provided through communication means, and it may also be provided in a state where it is stored in a storage medium such as CD-ROM.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The exemplary embodiments are chosen and described in order to best explain the principles of the invention and its practical applications, thereby enabling others skilled in the art to understand the invention for various exemplary embodiments and with the various modifications as are suited to the particular use contemplated. It is intended that the scope of the invention be defined by the following claims and their equivalents.

What is claimed is:

1. An image formation apparatus comprising:
an acquisition unit that reads an original and acquires image data;
a plurality of accommodation units that accommodate therein printing media on which images are to be formed;
an accommodated-printing-medium setting unit that sets an accommodated-printing-medium size which is a size of the printing medium accommodated in each of the accommodation unit, and an accommodated-printing-medium sort which is a sort of the printing medium;
a selected-printing-medium setting unit that sets a selected-printing-medium sort which is the sort of the printing medium for selecting any of the respective accommodation unit;
a determination unit that determines a determined-printing-medium size which is the size of the printing medium for forming thereon the image of the original read by the acquisition unit;
a selection unit that selects the accommodation unit in which the printing medium of the accommodated-printing-medium sort of single sort and the accommodated-printing-medium size corresponding to the determined-printing-medium size is accommodated, even when the selected-printing-medium sort does not correspond to the single sort in a selection function, in a case where the accommodated-printing-medium sort as to the accommodation unit which is selected by the selection function of selecting the accommodation unit that accommodates therein the printing medium of the accommodated-printing-medium size corresponding to the determined-printing-medium size and the accommodated-printing-medium sort corresponding to the selected-printing-medium sort is the single sort; and
an image formation unit that forms the image on the printing medium which is accommodated in the accommodation unit selected by the selection unit, on the basis of the image data acquired by the acquisition unit.

2. An image formation apparatus as defined in claim 1, wherein when the accommodation unit which is selected by the selection function accommodate therein printing media of plurality of sorts as to the accommodated-printing-medium size corresponding to the determined-printing-medium size, and the selected-printing-medium sort does not correspond to any of the plurality of sorts, the selection unit does not select any of the accommodation unit in the selection function.

3. A computer readable medium storing a program causing a computer to execute a process for controlling, the process comprising:
reading an original and acquiring image data;
setting an accommodated-printing-medium size which is a size of a printing medium accommodated in each of a plurality of accommodation units for accommodating therein printing media to be formed with images, and an accommodated-printing-medium sort which is a sort of the printing medium;
setting a selected-printing-medium sort which is the sort of the printing medium for selecting any of the respective accommodation unit;
determining a determined-printing-medium size which is the size of the printing medium for forming thereon the image of the original read by the acquiring;
selecting the accommodation unit in which the printing medium of the accommodated-printing-medium sort of single sort and the accommodated-printing-medium size corresponding to the determined-printing-medium size is accommodated, even when the selected-printing-medium sort does not correspond to the single sort in a selection function, in a case where the accommodated-printing-medium sort as to the accommodation unit which is selected by the selection function of selecting the accommodation unit that accommodates therein the printing medium of the accommodated-printing-medium size corresponding to the determined-printing-medium size and the accommodated-printing-medium sort corresponding to the selected-printing-medium sort is the single sort; and
forming the image on the printing medium which is accommodated in the accommodation unit selected by the selecting, on the basis of the image data acquired by the acquiring.
